(19) United States
(12) Patent Application Publication
(10) Pub. No.: US 2020/0189351 A1
(43) Pub. Date: Jun. 18, 2020

(54) VEHICLE HVAC SYSTEM

(71) Applicant: DENSO International America, Inc., Southfield, MI (US)

(72) Inventors: Reilly MULLETT, Livonia, MI (US); Patrick GANNON, Wolverine Lake Village, MI (US); Hayato ASANO, West Bloomfield, MI (US)

(21) Appl. No.: 16/709,142

(22) Filed: Dec. 10, 2019

Related U.S. Application Data
(60) Provisional application No. 62/779,521, filed on Dec. 14, 2018.

(51) Int. Cl. B60H 1/00

(52) U.S. Cl. CPC B60H 1/00664; B60H 2001/00721; B60H 1/0055

(57) ABSTRACT

A vehicle heating, ventilation, and air conditioning (HVAC) unit. The vehicle HVAC unit includes an evaporator, a driver side face outlet, and a passenger side face outlet. A face airflow control door extends across both the driver side face outlet and the passenger side face outlet. A divider separates a driver side airflow path from a passenger side airflow path. The driver side airflow path extends across the evaporator to the driver side face outlet, and the passenger side airflow path extends across the evaporator to the passenger side face outlet. A passenger side airflow control door is within the passenger side airflow path between the face airflow control door and the evaporator. The passenger side airflow control door is movable to block airflow through the passenger side airflow path to the passenger side face outlet.

### CROSS-REFERENCE TO RELATED APPLICATION

This patent application claims the benefit of U.S. Provisional Patent Application No. 62/779,521 filed on Dec. 14, 2019, the entire disclosure of which is incorporated herein by reference.

### FIELD

The present disclosure relates to a heating, ventilation, and air conditioning (HVAC) system for a vehicle.

### BACKGROUND

This section provides background information related to the present disclosure, which is not necessarily prior art.

Vehicles typically include a heating, ventilation, and air conditioning (HVAC) system to heat or cool a passenger cabin, as well as defrost at least a front windshield. While current HVAC systems are suitable for their intended use, they are subject to improvement. For example, current HVAC systems are limited with respect to where airflow can be concentrated within the passenger cabin. As a result, current HVAC systems may unnecessarily heat or cool an unoccupied area of the passenger cabin, thereby wasting energy. The present disclosure advantageously provides for an improved HVAC system that is more efficient as compared to current HVAC systems, which may increase fuel economy of the vehicle.

### SUMMARY

This section provides a general summary of the disclosure, and is not a comprehensive disclosure of its full scope or all of its features.

The present disclosure includes a vehicle heating, ventilation, and air conditioning (HVAC) unit having an evaporator, a driver side face outlet, and a passenger side face outlet. A face airflow control door extends across both the driver side face outlet and the passenger side face outlet. A divider separates a driver side airflow path from a passenger side airflow path. The driver side airflow path extends across the evaporator to the driver side face outlet. The passenger side airflow path extends across the evaporator to the passenger side face outlet. A passenger side airflow control door is within the passenger side airflow path between the face airflow control door and the evaporator, and is movable to block airflow through the passenger side airflow path to the passenger side face outlet.

The present disclosure further includes a vehicle heating, ventilation, and air conditioning (HVAC) unit having a heater, a driver side foot outlet, and a passenger side foot outlet. An airflow control door is movable to control airflow through the driver side foot outlet and the passenger side foot outlet. A divider separates a driver side airflow path from a passenger side airflow path. The driver side airflow path extends across the heater to the driver side foot outlet. The passenger side airflow path extends across the heater to the passenger side foot outlet. A passenger side airflow control door is within the passenger side airflow path between the airflow control door and the heater. The passenger side airflow control door is movable to block airflow through the passenger side airflow path to the passenger side foot outlet.

The present disclosure also includes a vehicle heating, ventilation, and air conditioning (HVAC) unit having a driver side face outlet, a passenger side face outlet, a driver side foot outlet, and a passenger side foot outlet. A face airflow control door is movable between an open position and a closed position in which the face airflow control door extends across both the driver side face outlet and the passenger side face outlet to restrict airflow therethrough. A driver side airflow path extends from an evaporator to the driver side face outlet and the driver side foot outlet. A passenger side airflow path extends from the evaporator to the passenger side face outlet and the passenger side foot outlet. A divider is between the driver side airflow path and the passenger side airflow path. A passenger side airflow control door is within the passenger side airflow path, and is movable to control airflow through the passenger side airflow path.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 is a perspective view of an exemplary heating, ventilation, and air conditioning (HVAC) unit in accordance with the present disclosure;

FIG. 2A is a top view of the HVAC unit of FIG. 1 illustrating a passenger-side airflow control door in a closed position, and a defrost airflow control door in a closed position;

FIG. 2B is a top view of HVAC unit of FIG. 1 illustrating the passenger-side airflow control door in an open position, and the defrost airflow control door in the closed position;

FIG. 3 is a cross-sectional view of the HVAC unit of FIG. 1 taken along line 3-3 of FIG. 2A;

FIG. 4A is a cross-sectional view of only a passenger side of the HVAC unit of FIG. 1 taken along line 4A-4A of FIG. 2B configured in a driver and passenger cooling/vent mode;

FIG. 4B is a cross-sectional view of only the passenger side of the HVAC unit of FIG. 1 configured in a driver-only cooling/vent mode;

FIG. 4C is a cross-sectional view of only the passenger side of the HVAC unit of FIG. 1 configured in a driver and passenger heat mode; and

FIG. 4D is a cross-sectional view of only the passenger side of the HVAC unit of FIG. 1 configured in a driver-only heat mode.

Corresponding reference numerals indicate corresponding parts throughout the several views of the drawings.

### DETAILED DESCRIPTION

Example embodiments will now be described more fully with reference to the accompanying drawings.

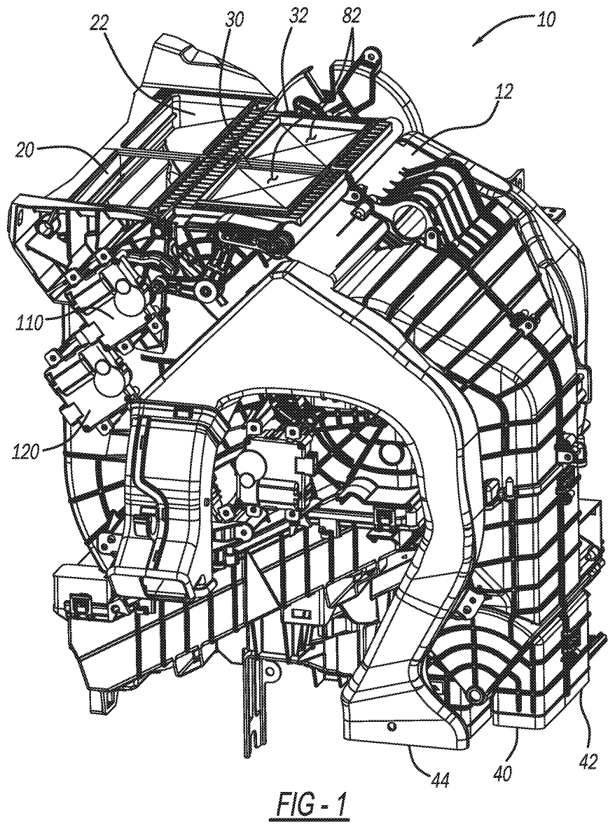

With initial reference to FIGS. 1, 2A, 2B, and 3, a heating, ventilation, and air conditioning (HVAC) unit in accordance with the present disclosure is illustrated at reference numeral 10. The HVAC unit 10 may be configured for use with any suitable vehicle, such as, but not limited to, any suitable passenger vehicle, mass transit vehicle, utility vehicle, recreational vehicle, construction vehicle/equipment, military vehicle/equipment, watercraft, aircraft, etc. The HVAC unit 10 may also be configured for use in any suitable non-vehicular application, such as for heating and/or cooling any suitable building or other structure.

The exemplary HVAC unit 10 illustrated throughout the drawings includes a case 12. The case 12 defines various airflow outlets. For example, the case 12 defines a driver side face outlet 20 and a passenger side face outlet 22. The driver side face outlet 20 is in communication with driver side face vents in a vehicle passenger cabin to deliver airflow to the upper portion of the driver side of the passenger cabin. The passenger side face outlet 22 is in communication with face vents on the passenger side of the vehicle to deliver airflow to an upper portion of the passenger side of the passenger cabin.

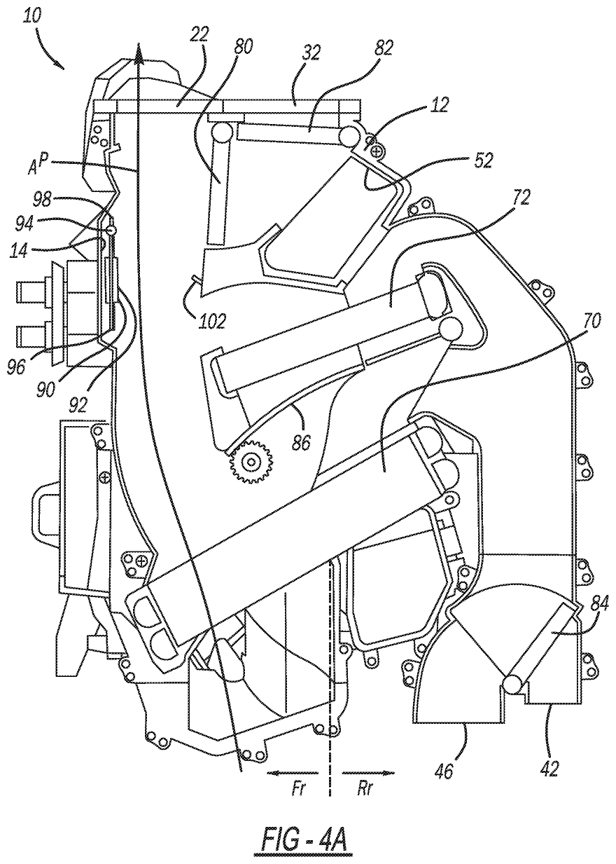

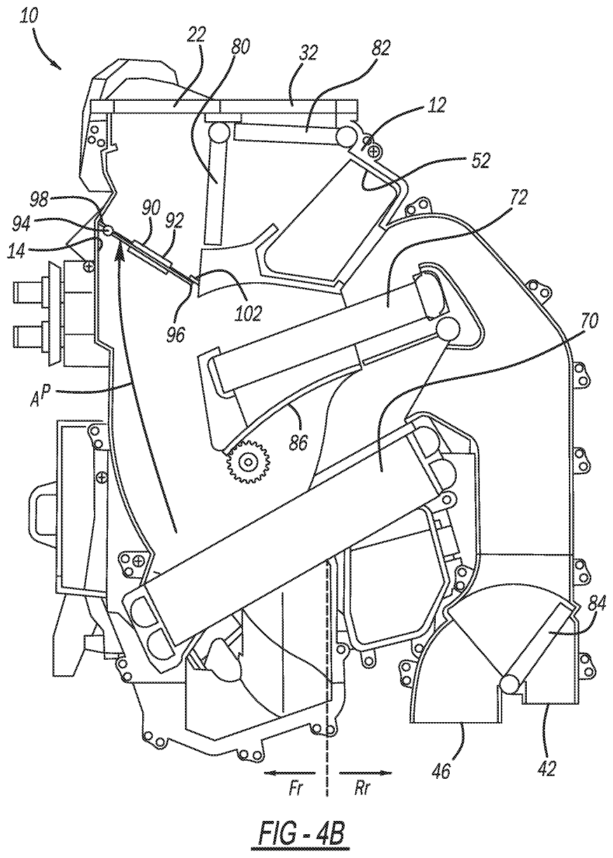

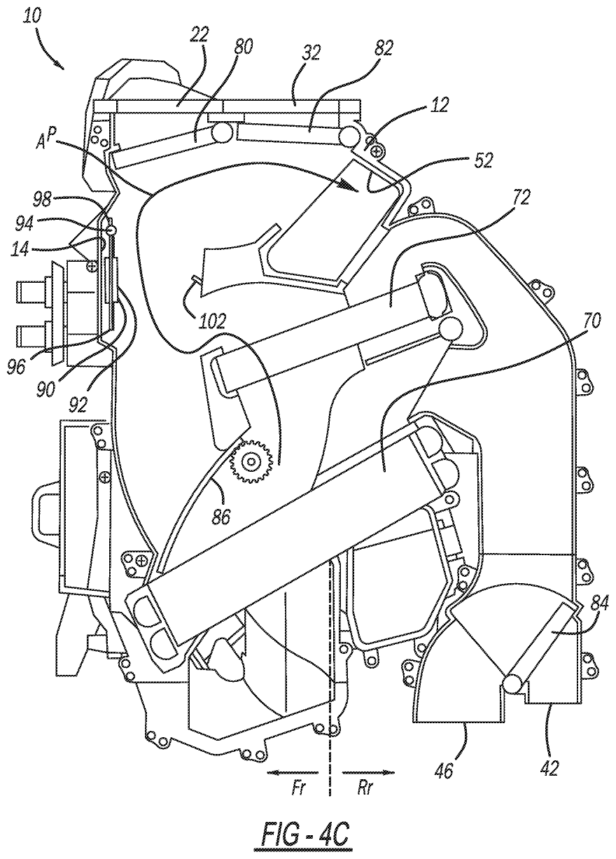

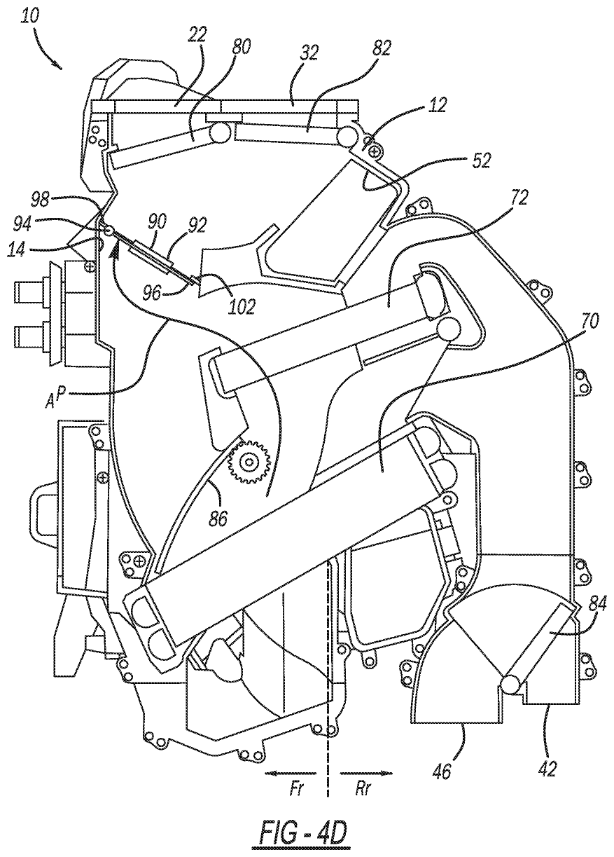

The case 12 further defines a driver side front defrost outlet 30 and a passenger side front defrost outlet 32. The driver side front defrost outlet 30 is in communication with defrost vents within the passenger cabin on the driver side thereof to direct warm defrost air to a windshield of the vehicle. The passenger side front defrost outlet 32 is in communication with defrost vents on the passenger side of the passenger cabin to direct warm defrost air to the windshield. With particular reference to FIG. 1, the case 12 further defines a driver side rear vent outlet 40 and a driver side rear heat outlet 44, which are in communication with one or more rear foot outlets of the passenger cabin on the driver side. As illustrated in FIG. 1 and FIGS. 4A-4D, a passenger side rear vent outlet 42 and a passenger side rear heat outlet 46 are in communication with rear foot outlets of the passenger cabin on the passenger side.

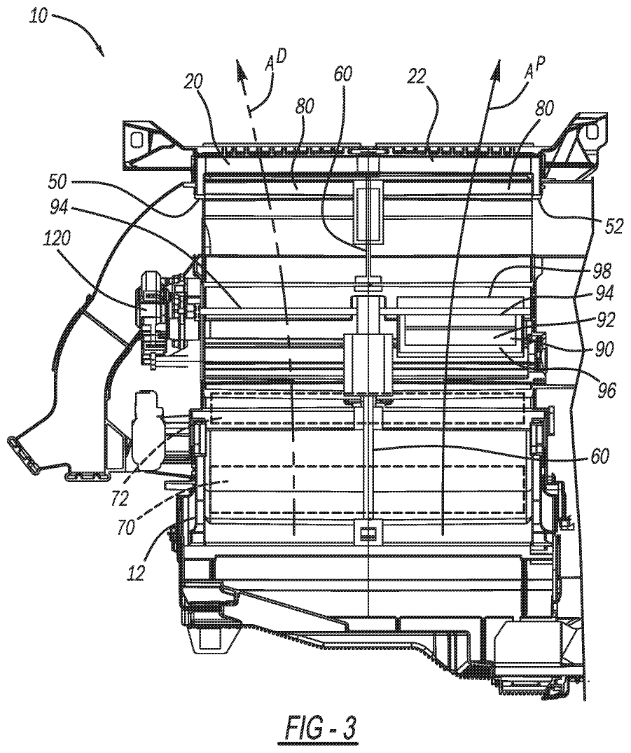

With particular reference to FIG. 3, the case 12 also defines a driver side front foot outlet 50 and a passenger side front foot outlet 52. The driver side front foot outlet 50 is in communication with foot vents on the driver side of the passenger cabin. The passenger side front foot outlet 52 is in communication with foot vents on the passenger side of the passenger cabin.

With continued reference to FIG. 3, a divider 60 is arranged at an approximate center of the HVAC unit 10, such as about halfway between the driver side front foot outlet 50 and the passenger side front foot outlet 52. The divider 60 is arranged between the driver side face outlet 20 and the passenger side face outlet 22, as well as between the driver side front defrost outlet 30 and the passenger side front defrost outlet 32.

The divider 60 divides the HVAC unit 10 into a driver side and a passenger side. On the driver side is a driver side airflow path A^{D}, and on the passenger side is a passenger side airflow path A^{P} (see FIG. 3, for example). The driver side airflow path A^{D} passes across an evaporator 70 and a heater 72 to the driver side face outlet 20, the driver side front defrost outlet 30, and the driver side front foot outlet 50. The passenger side airflow path A^{P} passes over the evaporator 70 and the heater 72 to the passenger side face outlet 22, the passenger side front defrost outlet 32, and the passenger side front foot outlet 52. FIGS. 4A-4D are cross-section views taken of only the passenger side of the HVAC unit 10. As a result, FIGS. 4A-4D show passenger side airflow path A^{P}, but not driver side airflow path A^{D}. FIG. 3 illustrates both airflow paths A^{P} and A^{D}.

The HVAC unit 10 includes various airflow control doors to control airflow through and out of the case 12. For example and as illustrated in FIGS. 3 and 4A-4D, a face airflow control door 80 is arranged at the driver side face outlet 20 and the passenger side face outlet 22. The face airflow control door 80 extends across the divider 60 from the driver side face outlet 20 to the passenger side face outlet 22. The divider 60 thus includes any suitable clearance or opening sufficient to allow the face airflow control door 80 to extend across the divider 60. The divider 60 is rotatable in any suitable manner, such as with any suitable actuation device 110. As illustrated in FIG. 1, the actuation device 110 may be a servo mounted at an exterior of the case 12. The face airflow control door 80 is movable between an open position (see FIGS. 4A and 4B) and a closed position (see FIGS. 4C and 4D). In the open position of FIGS. 4A and 4B, the face airflow control door 80 does not restrict airflow from exiting the case 12 through the driver side face outlet 20 and the passenger side face outlet 22. In the open position, the face airflow control door 80 restricts airflow from flowing to the driver side front foot outlet 50 and the passenger side front foot outlet 52, as well as to the defrost outlets 30 and 32.

The defrost airflow control door 82 is illustrated throughout the figures in a closed position, thereby restricting airflow through the driver side front defrost outlet 30 and the passenger side front defrost outlet 32. The defrost airflow control door 82 is rotatable to an open position to open the driver side front defrost outlet 30 and the passenger side front defrost outlet 32 to allow airflow to exit the case 12 therethrough for defrosting any suitable surface, such as the windshield.

As illustrated in FIGS. 4A, 4B, 4C, and 4D, the HVAC unit 10 further includes a rear airflow control door 84, which is movable to control airflow through the driver side rear vent outlet 40, the passenger side rear vent outlet 42, the driver side rear heat outlet 44, and the passenger side rear heat outlet 46. Also within the case 12 is a temperature control door 86. The temperature control door 86 is movable to direct airflow around or across the heater 72 to control airflow temperature. Specifically, in the position illustrated in FIGS. 4A and 4B, the temperature control door 86 restricts airflow across the heater 72 in a vent or cooling mode so that airflow is not heated by the heater 72. In the position illustrated in FIGS. 4C and 4D, the temperature control door 86 directs and permits airflow across the heater 72 to heat the airflow in a heating mode, which is described further herein.

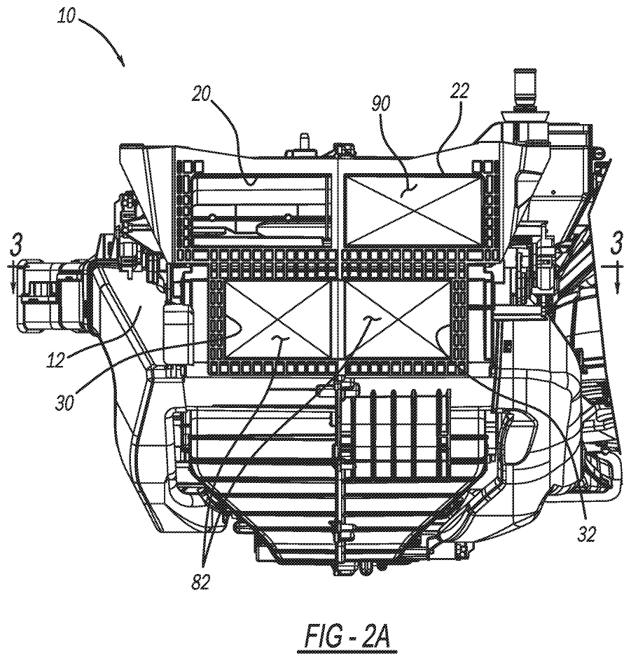

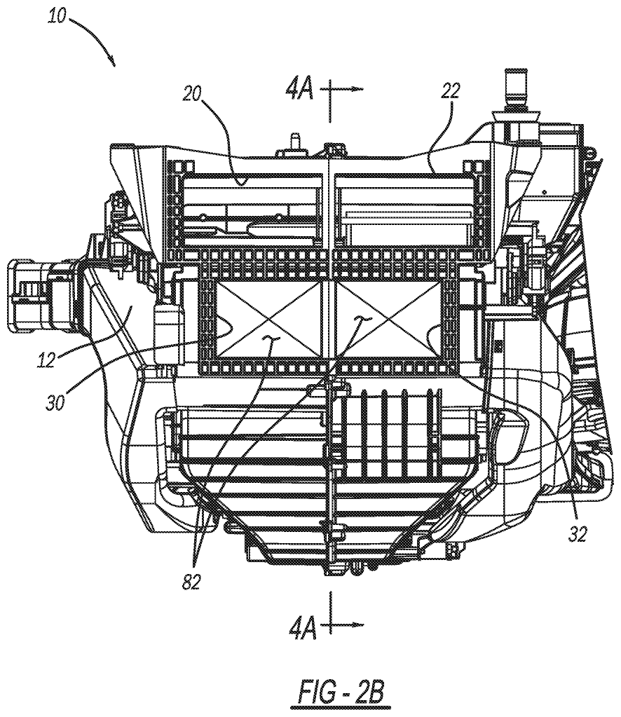

The HVAC unit 10 further includes a passenger side airflow control door 90 mounted within the case 12, as illustrated at least in FIGS. 2A, 3, and 4A-4D. The passenger side airflow control door 90 is arranged between the passenger side face outlet 22 and the evaporator 70. The passenger side airflow control door 90 includes a flap 92, which rotates about a shaft 94. The flap 92 is arranged along the passenger side airflow path A^{P} only. The flap 92 is confined to the passenger side of the divider 60 defining the passenger side airflow path A^{P}. The flap 92 does not extend across the divider 60 to the driver side defining the driver side airflow path A^{D}. The shaft 94 may be configured to extend across the divider 60 to the driver side, as illustrated in FIG. 3. The shaft 94 is rotated by any suitable actuator 120 (see FIGS. 1 and 3, for example). The actuator 120 may be any suitable actuator, such as a servo. In the examples illustrated, the actuator 120 is mounted at an exterior of the case 12. However, the actuator 120 may be arranged at any other suitable position. The divider 60 defines any suitable passageway or opening configured to accommodate the shaft 94 to allow the shaft 94 to extend from the passenger side of the divider 60 to the driver side of the divider 60.

The flap 92 of the passenger side airflow control door 90 includes an outer seal 96. The outer seal 96 extends about an outer periphery of the flap 92, as illustrated in FIG. 3 for example. On a side of the shaft 94 opposite to the flap 92 is an inner seal 98. The inner seal 98 is connected to the shaft 94 and/or the flap 92 such that the inner seal 98 rotates with both the shaft 94 and the flap 92. Mounted within the case 12 opposite to the passenger side airflow control door 90 is a seal tab 102. When the passenger side airflow control door 90 is rotated to the outer/closed position illustrated in FIGS. 4B and 4D, the outer seal 96 mates with the seal tab 102 and the inner seal 98 mates with an inner wall of the case 12 to define a seal about the passenger side airflow control door 90 preventing airflow from passing across the passenger side airflow control door 90. The outer seal 96, the inner seal 98, and the seal tab 102 may be made of any suitable material, such as any suitable polymeric material that is impermeable to airflow (i.e., able to block airflow).

Operation of the passenger side airflow control door 90 to restrict airflow from the HVAC unit 10 to only the driver side of the passenger cabin will now be described. FIG. 4A illustrates the HVAC unit 10 configured in a driver side and passenger side cooling/vent mode in which driver side airflow A^{D} flows out of the driver side face outlet 20, and passenger side airflow A^{P} flows out of the passenger side face outlet 22, because both the face airflow control door 80 and the passenger side airflow control door 90 are rotated to the open positions illustrated in FIG. 4A. The temperature control door 86 restricts airflow across the heater 72, and thus the airflow A^{D} and A^{P} exits the HVAC unit 10 as vented airflow or airflow cooled by the evaporator 70 when a vehicle compressor is active. In the open position, the passenger side airflow control door 90 sits within a recess 14 defined by the case 12 so as to not obstruct passenger side airflow A^{P}. With the face airflow control door 80 in the fully open position of FIG. 4A, both driver side airflow A^{D} and passenger side airflow A^{P} is blocked from flowing to the driver side front foot outlet 50 and the passenger side front foot outlet 52. In the fully open position, the face airflow control door 80 also blocks airflow to the driver side front defrost outlet 30 and the passenger side front defrost outlet 32. In the example illustrated, there is no airflow to the rear outlets 40, 42, 44, and 46 because a rear blower is not active.

FIG. 4B illustrates a driver side only cooling/vent mode in which passenger side airflow is blocked by the passenger side airflow control door 90, and thus only driver side airflow A^{D} exits the HVAC unit 10. In this driver side only mode, the passenger side airflow control door 90 is rotated by the actuator 120 to the closed position illustrated in FIG. 4B. In this closed position, the outer seal 96, the inner seal 98, and the seal tab 102 form an airtight seal as described above, and the passenger side airflow control door 90 blocks passenger side airflow A^{P} from flowing across the passenger side airflow control door 90 to the passenger side face outlet 22. The face airflow control door 80 is in the fully open position to block airflow to the driver side front foot outlet 50 and the passenger side front foot outlet 52. This driver only cooling/vent mode is typically activated when no passenger is seated in the vehicle. The passenger side airflow control door 90 advantageously cuts off the passenger side airflow A^{P}, thus reducing the overall amount of airflow that needs to be generated and cooled by the HVAC unit 10. Blower speed and compressor speed can therefore be reduced, thereby saving power and improving fuel economy of the vehicle. The advantages of this driver only cooling/vent mode are most significant during warm summer months when the blower and compressor are typically required to run at high speeds for extended periods of time.

FIG. 4C illustrates a driver and passenger heat mode in which the passenger side airflow control door 90 is in the open position whereby the flap 92 is seated in the recess 14 of the case 12 so as to not obstruct passenger side airflow A^{P}. The face airflow control door 80 and the defrost airflow control door 82 are rotated to their closed positions to block airflow through the face outlets 20, 22 and the defrost outlets 30, 32. The temperature control door 86 is rotated to direct both the driver side airflow A^{D} and the passenger side airflow A^{P} through the heater 72. The heated driver side airflow A^{D} exits the case 12 through the driver side front foot outlet 50 and the passenger side airflow A^{P} exits the case 12 through the passenger side front foot outlet 52. The rear blower is off and thus no airflow exits the case 12 through the rear outlets 40, 42, 44, 46.

When there are no passengers on the passenger side of the vehicle, and thus heat is only needed on the driver side, the passenger side airflow control door 90 is closed to place the HVAC unit 10 in a driver side only heat mode, as illustrated in FIG. 4D. In the driver side only heat mode, passenger side airflow A^{P} is blocked by the passenger side airflow control door 90. Because the passenger side airflow control door 90 is only on the passenger side of the divider 60, driver side airflow A^{D} is free to flow out of the case 12 through the driver side front foot outlet 50 to heat the driver. Because only enough airflow to heat the driver side is required, the blower may be operated at a reduced speed to generate less airflow, and the engine of the vehicle may be operated in a more economical manner because less airflow needs to be heated, thereby advantageously improving fuel economy.

The passenger side airflow control door 90 is thus advantageously able to block the passenger side airflow A^{P}, which blocks airflow out of the case 12 through the passenger side face outlet 22 and the passenger side front foot outlet 52, while permitting the driver side airflow A^{D} to flow out of the driver side face outlet 20 and/or the driver side front foot outlet 50. Without the passenger side airflow control door 90, it is not possible to block passenger side airflow A^{P} while not blocking driver side airflow A^{D} because the face airflow control door 80 is a common door for both the driver side face outlet 20 and the passenger side face outlet 22, and the defrost airflow control door 82 is a common door for the driver side front defrost outlet 30, the passenger side front defrost outlet 32, the driver side front foot outlet 50, and the passenger side front foot outlet 52. Thus, when no passengers are in the vehicle, the HVAC unit 10 may be configured to direct and provide heated, cooled, or vented airflow to only the driver side by moving the passenger side airflow control door 90 to the extended or closed position of FIG. 4B and FIG. 4D, thereby improving fuel economy because the blower, compressor, and engine may be operated more efficiently at lower speeds, thereby consuming less energy.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A vehicle heating, ventilation, and air conditioning (HVAC) unit comprising:
an evaporator;
a driver side face outlet and a passenger side face outlet;
a face airflow control door extending across both the driver side face outlet and the passenger side face outlet;
a divider separating a driver side airflow path from a passenger side airflow path, the driver side airflow path extending across the evaporator to the driver side face outlet, and the passenger side airflow path extending across the evaporator to the passenger side face outlet; and
a passenger side airflow control door within the passenger side airflow path between the face airflow control door and the evaporator movable to block airflow through the passenger side airflow path to the passenger side face outlet.

2. The vehicle HVAC unit of claim 1, wherein the passenger side airflow control door includes: a shaft extending across the divider from the driver side airflow path to the passenger side airflow path; and a flap mounted to the shaft, the flap confined to the passenger side airflow path.

3. The vehicle HVAC unit of claim 1, further comprising an actuation mechanism for opening and closing the passenger side airflow control door.

4. The vehicle HVAC unit of claim 3, wherein the actuation mechanism includes a dedicated servo mounted to an exterior of the vehicle HVAC unit.

5. The vehicle HVAC unit of claim 1, wherein with the face airflow control door in an open position and the passenger side airflow control door in a closed position, airflow exits the vehicle HVAC unit through the driver side face outlet and airflow is restricted from exiting the vehicle HVAC unit through the passenger side face outlet.

6. A vehicle heating, ventilation, and air conditioning (HVAC) unit comprising:
a heater;
a driver side foot outlet and a passenger side foot outlet;
an airflow control door movable to control airflow through the driver side foot outlet and the passenger side foot outlet;
a divider separating a driver side airflow path from a passenger side airflow path, the driver side airflow path extending across the heater to the driver side foot outlet, and the passenger side airflow path extending across the heater to the passenger side foot outlet; and
a passenger side airflow control door within the passenger side airflow path between the airflow control door and the heater, the passenger side airflow control door is movable to block airflow through the passenger side airflow path to the passenger side foot outlet.

7. The vehicle HVAC unit of claim 6, wherein the passenger side airflow control door includes: a shaft extending across the divider from the driver side airflow path to the passenger side airflow path; and a flap mounted to the shaft, the flap confined to the passenger side airflow path.

8. The vehicle HVAC unit of claim 6, further comprising an actuation mechanism for opening and closing the passenger side airflow control door.

9. The vehicle HVAC unit of claim 8, wherein the actuation mechanism includes a dedicated servo mounted to an exterior of the vehicle HVAC unit.

10. The vehicle HVAC unit of claim 6, wherein with the airflow control door in an open position and the passenger side airflow control door in a closed position, airflow exits the vehicle HVAC unit through the driver side foot outlet and airflow is restricted from exiting the vehicle HVAC unit through the passenger side foot outlet.

11. A vehicle heating, ventilation, and air conditioning (HVAC) unit comprising:
a driver side face outlet, a passenger side face outlet, a driver side foot outlet, and a passenger side foot outlet;
a face airflow control door movable between an open position and a closed position in which the face airflow control door extends across both the driver side face outlet and the passenger side face outlet to restrict airflow therethrough;
an evaporator;
a heater;
a divider dividing the HVAC unit into a driver side defining a driver side airflow path and a passenger side defining a passenger side airflow path, the driver side airflow path extending from the evaporator to the driver side face outlet and the driver side foot outlet, and the passenger side airflow path extending from the evaporator to the passenger side face outlet and the passenger side foot outlet; and
a passenger side airflow control door within the passenger side airflow path movable to control airflow through the passenger side airflow path.

12. The vehicle HVAC unit of claim 11, wherein:
the divider extends across the evaporator and the heater;
the divider is between the driver side foot outlet and the passenger side foot outlet; and
the divider is between the driver side face outlet and the passenger side face outlet.

13. The vehicle HVAC unit of claim 11, wherein the passenger side airflow control door includes: a shaft extending across the divider from the driver side airflow path to the passenger side airflow path; and a flap mounted to the shaft, the flap confined to the passenger side airflow path.

14. The vehicle HVAC unit of claim 13, further comprising an actuation mechanism for rotating the passenger side airflow control door by rotating the shaft.

15. The vehicle HVAC unit of claim 14, wherein the actuation mechanism is mounted to an exterior of a case of the vehicle HVAC unit.

16. The vehicle HVAC unit of claim 14, wherein the actuation mechanism is a servo.

17. The vehicle HVAC unit of claim 15, wherein the case defines a recess sized and shaped to accommodate the passenger side airflow control door when in an open position.

18. The vehicle HVAC unit of claim 13, wherein the passenger side airflow control door further includes an outer seal extending about an outer edge of the flap and an inner seal on a side of the shaft opposite to the outer seal.

19. The vehicle HVAC unit of claim 11, wherein:
the passenger side airflow control door is movable to an open position to permit airflow through the passenger side airflow path from the evaporator to the passenger side face outlet and the passenger side foot outlet; and
the passenger side airflow control door is movable to a closed position in which the passenger side airflow control door extends across the passenger side airflow path to restrict airflow through the passenger side airflow path from the evaporator to the passenger side face outlet and the passenger side foot outlet.
